(19) United States
(12) Patent Application Publication
(10) Pub. No.: US 2026/0323065 A1
(43) Pub. Date: Oct. 15, 2026

(54) METHOD FOR ILLUMINATION COMPENSATION IN GEOMETRIC PARTITIONING MODE-BASED PREDICTION

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Min Hun Lee, Uijeongbu-si (KR); Joo Hyung Byeon, Seoul (KR); Dong Gyu Sim, Seoul (KR); Jin Heo, Yongin-si (KR); Jung Ah Choi, Seoul (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/483,916

(22) PCT Filed: May 7, 2024
(86) PCT No.: PCT/KR2024/006091

§ 371 Date: Nov. 12, 2025

(30) Foreign Application Priority Data
May 15, 2023 (KR) 1020230062654
May 3, 2024 (KR) 1020240059176

(51) Int. Cl. H04N 19/50; H04N 19/105; H04N 19/119; H04N 19/137; H04N 19/159; H04N 19/176; H04N 19/463

(52) U.S. Cl. CPC H04N 19/50; H04N 19/105; H04N 19/119; H04N 19/137; H04N 19/159; H04N 19/176; H04N 19/463

(57) ABSTRACT

A video decoding device uses illumination compensation in a geometric partitioning mode-based prediction. The device decodes a GPM index and a candidate index, constructs a GPM candidate list, and partitions the current block into two partitioned blocks according to the GPM index. The device derives motion information from the GPM candidate list by using the candidate index for an inter-partitioned block utilizing motion compensation and generates a reference block of the inter-partitioned block by using the motion information. The device obtains local LIC parameters that define a linear relationship between the reference block and the inter-partitioned block and generates a final prediction block of the inter-partitioned block by applying the LIC to the reference block of the inter-partitioned block based on the LIC parameters. The device generates final predicted signals of the current block based on the final prediction block of the inter-partitioned block.

### TECHNICAL FIELD

The present disclosure relates to a video coding method and an apparatus using illumination compensation in a geometric partitioning mode-based prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In VVC, geometric partitioning mode (GPM) is adopted as an inter prediction technique to perform prediction according to a more flexible partitioning than square and rectangular partitioning. In GPM technique, an encoder provides a decoder with a mode index indicating one of the predefined geometric partitioning modes and motion information of two partitioned regions. The decoder uses the transmitted information to compensate for the motion of the two partitioned regions and uses a blending matrix according to the geometric partitioning mode to weighted-sum the two partitioned regions and thereby generating the final predicted signals of the current block.

When generating predicted signals of the current block by using inter prediction-based motion compensation, local or global illumination changes may occur between the current frame and the reference frame. Local illumination compensation (LIC) is a technique that can improve the prediction efficiency of the current block by compensating for the changed illumination values. Therefore, to improve video coding efficiency and video quality, there is a need for a method of efficiently utilizing illumination compensation when performing GMP-based inter prediction.

### DISCLOSURE

### Technical Problem

The present disclosure seeks to provide a video coding method and an apparatus that, when a prediction is performed on a current block according to geometric partitioning mode, apply illumination compensation to predicted signals of the current block to compensate for local or global illumination changes between the current frame and a reference frame.

### Technical Solution

At least one aspect of the present disclosure provides a method of reconstructing a current block by a video decoding apparatus. The method includes decoding a geometric partitioning mode (GPM) index and a candidate index from a bitstream. The method also includes constructing a GPM candidate list, and partitioning the current block into two partitioned blocks according to the geometric partitioning mode index. The method also includes deriving motion information from the GPM candidate list by using the candidate index for an inter-partitioned block utilizing motion compensation, and at least one inter-partitioned block exists between the partitioned blocks. The method also includes generating a reference block of the inter-partitioned block by using the motion information.

The method also includes obtaining local illumination compensation parameters (LIC parameters) that define a linear relationship between the reference block and the inter-partitioned block when a local illumination compensation (LIC) applied. The method also includes generating a final prediction block of the inter-partitioned block by applying the LIC to the reference block of the inter-partitioned block based on the LIC parameters.

Another aspect of the present disclosure provides a method of encoding a current block by a video encoding apparatus. The method includes determining a geometric partitioning mode (GPM) index and a candidate index. The method also includes constructing a GPM candidate list, and partitioning the current block into two partitioned blocks according to the geometric partitioning mode index. The method also includes deriving motion information from the GPM candidate list by using the candidate index for an inter-partitioned block utilizing motion compensation, and at least one inter-partitioned block exists between the partitioned blocks. The method also includes generating a reference block of the inter-partitioned block by using the motion information. The method also includes obtaining local illumination compensation parameters (LIC parameters) that define a linear relationship between the reference block and the inter-partitioned block when a local illumination compensation (LIC) applied. The method also includes generating a final prediction block of the inter-partitioned block by applying the LIC to the reference block of the inter-partitioned block based on the LIC parameter.

Yet another aspect of the present disclosure provides a method of providing video data to a video decoding apparatus. The method includes encoding the video data into a bitstream, and transmitting the bitstream to the video decoding apparatus. Here, the encoding of the video data includes determining a geometric partitioning mode (GPM) index and a candidate index. The encoding of the video data also includes constructing a GPM candidate list, and partitioning a current block into two partitioned blocks according to the geometric partitioning mode index. The encoding of the video data also includes deriving motion information from the GPM candidate list by using the candidate index for an inter-partitioned block utilizing motion compensation, and at least one inter-partitioned block exists between the partitioned blocks. The encoding of the video data also includes generating a reference block of the inter-partitioned block by using the motion information, The encoding of the video data also includes obtaining local illumination compensation parameters (LIC parameters) that define a linear relationship between the reference block and the inter-partitioned block when a local illumination compensation (LIC) applied. The encoding of the video data also includes generating a final prediction block of the inter-partitioned block by applying the LIC to the reference block of the inter-partitioned block based on the LIC parameters.

### Advantageous Effects

As described above, the present disclosure provides a video coding method and an apparatus that, when a prediction is performed on a current block according to geometric partitioning mode, apply the illumination compensation to the predicted signals of the current block to compensate for local or global illumination changes between the current frame and a reference frame. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating block partitioning according to geometric partitioning.

FIGS. 7A and 7B are diagrams illustrating straight lines that split blocks into two parts.

FIG. 8 is a diagram illustrating a geometric partitioning mode (GPM) merge list used for geometric motion prediction.

FIG. 9 is a block diagram showing in detail a part of a video decoding apparatus according to at least one embodiment of the present disclosure.

FIG. 10 is a flowchart of the operation of a prediction performer, according to at least one embodiment of the present disclosure.

FIG. 11 is a flowchart of a method of performing local illumination compensation, according to at least one embodiment of the present disclosure.

FIG. 12 is a diagram illustrating the definition of a template according to an angle index, according to at least one embodiment of the present disclosure.

FIG. 13 is a diagram illustrating the definition of a template according to another embodiment of the present disclosure.

FIG. 14 is a flowchart of a method of encoding a current block by a video encoding apparatus, according to at least one embodiment of the present disclosure.

FIG. 15 is a flowchart of a method of reconstructing a current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

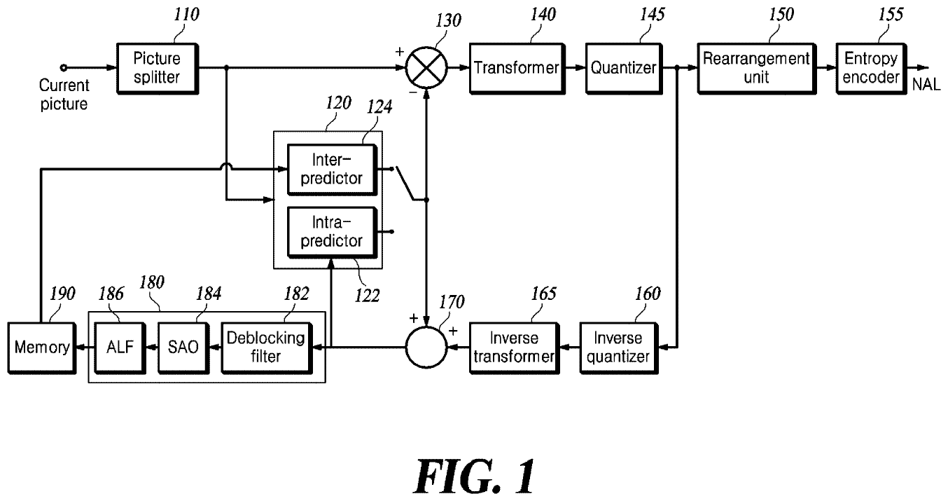

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

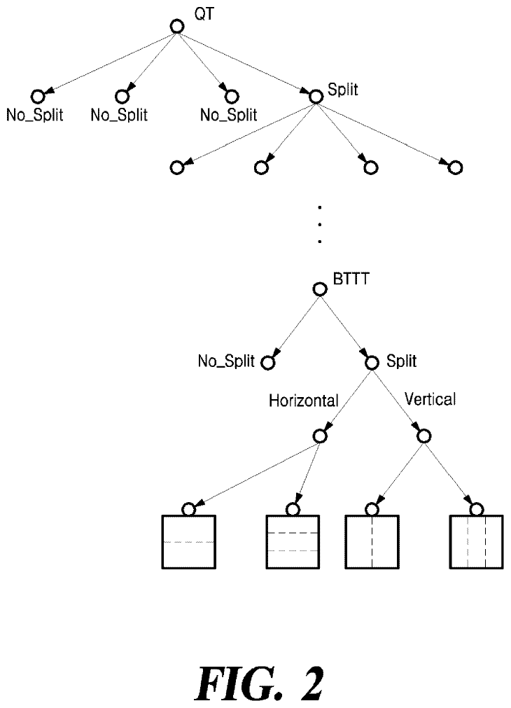

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape. The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

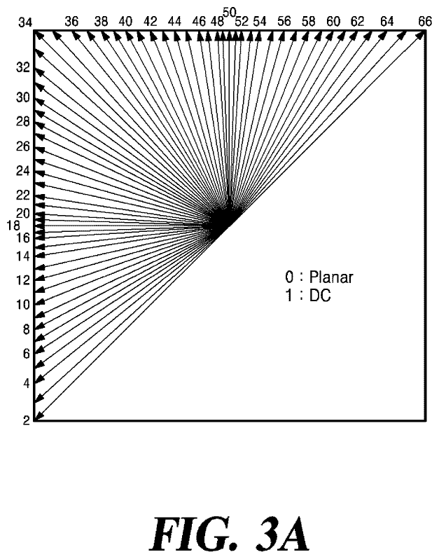

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like.

When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

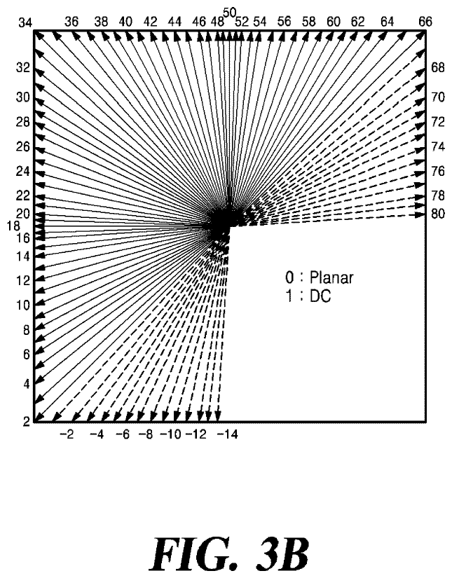

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

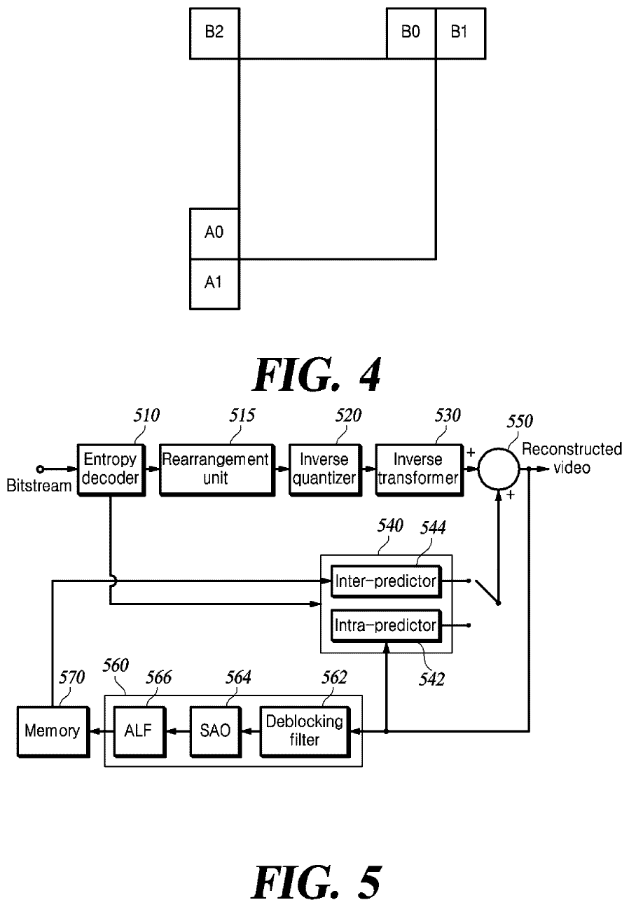

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that, when a prediction is performed on a current block according to geometric partitioning mode, apply illumination compensation to the predicted signals of the current block to compensate for local or global illumination changes between the current frame and the reference frame.

The following embodiments may be performed by the inter predictor 124 in the video encoding device. The following embodiments may also be performed by the inter predictor 544 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

I-1. Merge/Skip Mode of Inter Prediction and Merge Mode with Motion Vector Difference (MMVD)

The following describes a method of constructing a merge candidate list of motion information in the merge/skip mode of inter prediction. To support the merge/skip mode, the video encoding apparatus may construct the merge candidate list by selecting a preset number (e.g., 6) of merge candidates.

The video encoding apparatus searches for spatial merge candidates. The video encoding apparatus searches for spatial merge candidates from neighboring blocks, as shown in FIG. 4. Up to four spatial merge candidates may be selected.

The video encoding apparatus searches for temporal merge candidates. The video encoding apparatus may add as a temporal merge candidate a block co-located with the current block, which is within a reference picture other than the current picture where the target block is located. Here, the reference picture may be the same as or different from the reference picture used to predict the current block. One temporal merge candidate may be selected.

The video encoding apparatus searches for history-based motion vector predictor (HMVP) candidates. The video encoding apparatus may store the motion vectors of the previous h CUs (where h is a natural number) in a table and may use the motion vectors as merge candidates. The size of the table is 6, and the table stores the motion vectors of the previous CUs in a first-in first-out (FIFO) manner. This indicates that up to 6 HMVP candidates may be stored in the table. The video encoding apparatus may set as merge candidates the most recent motion vectors among the HMVP candidates stored in the table.

The video encoding apparatus searches for pairwise average MVP (PAMVP) candidates. The video encoding apparatus may set as a merge candidate the average of the motion vectors of the first and second candidates in the merge candidate list.

If the merge candidate list cannot be filled even after performing all of the above search processes, i.e., if the preset number of merge candidates cannot be recruited, the video encoding apparatus adds zero motion vectors as merge candidates.

In terms of coding efficiency optimization, the video encoding apparatus may determine a merge index that indicates one candidate in the merge candidate list. The video encoding apparatus may use the merge index to derive a motion vector predictor (MVP) from the merge candidate list, and then may determine the MVP as the motion vector of the current block. Additionally, the video encoding apparatus may signal the merge index to the video decoding apparatus.

In skip mode, the video encoding apparatus uses the same motion vector transmission method as in merge mode, but does not transmit the residual block that equals to the difference between the current block and the prediction block.

The above-described method of constructing the merge candidate list may be performed equally by the video decoding apparatus. The video decoding apparatus may decode the merge index. The video decoding apparatus may use the merge index to derive the MVP from the merge candidate list, and then may determine the MVP as the motion vector of the current block.

On the other hand, when using merge mode with motion vector difference (MMVD) technology, the video encoding apparatus may derive the MVP from the merge candidate list by using the merge index. For example, the first or second candidate in the merge candidate list may be used as the MVP. Additionally, from the perspective of coding efficiency optimization, the video encoding apparatus determines a distance index and a direction index.

The video encoding apparatus may derive the motion vector difference (MVD) by using the distance index and direction index, and then may reconstruct the motion vector of the current block by summing the MVD and MVP. In addition, the video encoding apparatus may signal the merge index, the distance index, and the direction index to the video decoding apparatus.

The above-described MMVD technique may be performed equally by the inter predictor 544 in the video decoding apparatus. The video decoding apparatus may decode the merge index, the distance index, and the direction index. The video decoding apparatus may construct the merge candidate list and then may derive the MVP from the merge candidate list by using the merge index. The video decoding apparatus may use the distance index and direction index to derive the MVD, and then may sum the MVD and MVP to reconstruct the motion vector of the current block.

### I-2. Advanced Motion Vector Prediction Mode (AMVP Mode) of Inter Prediction

The following embodiments are described with a focus on the inter predictor 124 within the video encoding apparatus, but as mentioned earlier, they may also be performed by the inter predictor 544 in the video decoding apparatus.

The following describes the method of constructing a candidate list of motion information in the Advanced Motion Vector Prediction mode (AMVP mode) of inter prediction. To support the AMVP mode, the inter predictor 124 in the video encoding apparatus may select a preset number (e.g., two) of candidates to form the candidate list.

The video encoding apparatus searches for spatial candidates. The video encoding apparatus searches for spatial candidates from neighboring blocks, as illustrated in FIG. 4. Up to two spatial candidates may be selected.

The video encoding apparatus searches for temporal candidates. The video encoding apparatus may add as a temporal candidate a block that is co-located with the current block and is within a reference picture that is not the current picture holding the target block. Here, the reference picture may be the same as or different from the reference picture used to predict the current block. One temporal candidate may be selected.

If the candidate list cannot be filled even after performing all of the above search processes, i.e., if the preset number of merge candidates cannot be recruited, the video encoding apparatus adds zero motion vectors as merge candidates.

In terms of coding efficiency optimization, the video encoding apparatus may determine a candidate index that indicates one candidate in the candidate list. The video encoding apparatus may use the candidate index to derive MVP (motion vector predictor) from the candidate list. Furthermore, in terms of coding efficiency optimization, the video encoding apparatus determines the motion vector and then subtracts MVP from the motion vector to calculate MVD. Furthermore, the video encoding apparatus may signal the candidate index and MVD to the video decoding apparatus.

The above-described method of constructing the AMVP candidate list may be performed equally by the inter predictor 544 in the video decoding apparatus. The video decoding apparatus may decode the candidate index and MVD. The video decoding apparatus may use the candidate index to derive MVP from the candidate list. The video decoding apparatus may sum the MVD and the MVP to reconstruct the motion vector of the current block.

### I-3. Geometric Partitioning Mode (GPM) of Inter Prediction

The following embodiments are described with a focus on the video decoding apparatus, but they can be implemented in the same or similar manner in the video encoding apparatus.

In versatile video coding (VVC), geometric partitioning mode (GPM) uses prediction units of various shapes rather than rectangular shapes.

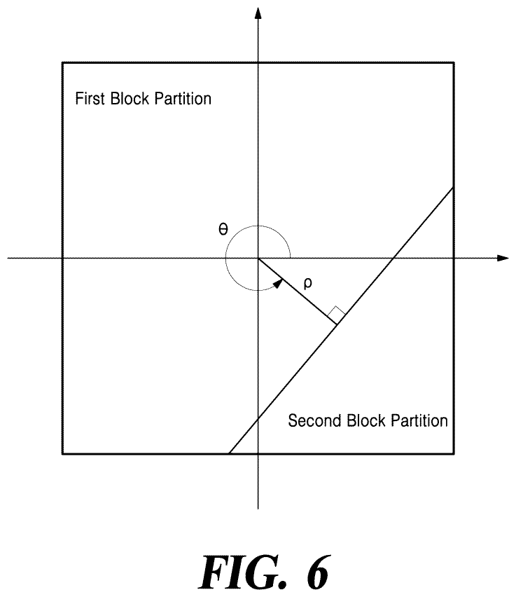

FIG. 6 is a diagram illustrating block partitioning according to geometric partitioning.

The video decoding apparatus divides the current block into two parts by a straight line perpendicular to a line segment with a certain angle θ and a certain distance p from the center of the block. Hereinafter, the two divided blocks are referred to as the first block partition and the second block partition. Block partition is used interchangeably with partitioned block. The straight line that divides the current block is called the partitioning boundary.

Here, the center of the block represents a single virtual position with the current block before partitioning where the ½ position of the height of the block and the ½ position of the width of the block intersect. The angle θ represents the angle rotated counterclockwise from the virtual horizontal axis passing through the center of the block to the line segment perpendicular to the partitioning boundary. The distance p represents the distance between the center of the block and the partitioning boundary.

As described above, the straight line that divides the block into two parts, i.e., the partitioning boundary, divides the current block into two different block partitions. The video decoding apparatus uses the above-described geometric partition to divide the current block into two blocks, the first block partition and the second block partition, which perform separate predictions based on the partitioning boundary.

As an example, in the conventional GPM, information on the partitioning boundary as illustrated in FIG. 6 is signaled from the video encoding apparatus to the video decoding apparatus. The video decoding apparatus may use the parsed partitioning boundary information to decode the geometric block partitions of the current block. Here, the partitioning boundary information may include the angle θ and distance ρ that are based on the center of the block. Additionally, the video encoding apparatus may further signal information indicating whether GPM is to be applied, to the video decoding apparatus.

Hereinafter, the information on the partitioning boundary according to the geometric partitioning mode is used interchangeably with geometric partitioning mode information, geometric partition information, or partitioning information.

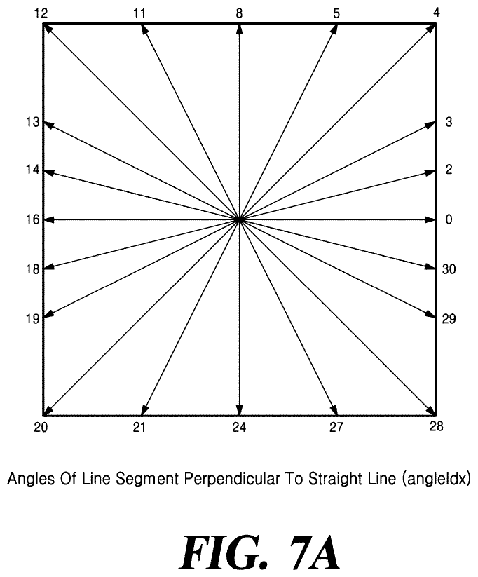

FIGS. 7A and 7B are diagrams illustrating straight lines that split blocks into two parts.

As another example, a lookup table may be configured to include combinations of angles and distances that divide the current block into a first block partition and a second block partition, as shown in FIG. 7A, FIG. 7B, and Table 1. Then, an index indicating the combination of an angle and a distance in the lookup table may be signaled from the video encoding apparatus to the video decoding apparatus. The combinations of angles and distances corresponding to the respective indices may be defined based on a fixed lookup table in accordance with an agreement between the video encoding apparatus and the video decoding apparatus. As a modification, the lookup table may be adaptively reconfigured in accordance with a pre-agreed rule.

As described above, the geometric partition shape is based on a partitioning boundary which is a straight line representing the two partitions of a block. Such information of straight line may include an index distanceIdx representing the distance ρ from the center of the block to the partitioning boundary, and an index angleIdx representing the angle θ of a line segment perpendicular to the partitioning boundary. The indices indicating the angles of the line segment perpendicular to the partitioning boundary may be set as shown in FIG. 7A. Furthermore, the 64 geometric partition shapes based on these angles and distances may be set as shown in FIG. 7B.

The 64 geometric partition shapes may be signaled by using the syntax merge_gpm_partition_idx which is an index indicating the geometric partition shape, as shown in Table 1. Namely, the forms of dividing the current block into the first block partition and the second block partition according to various angles and distances can be efficiently signaled by using a single index.

TABLE 1

| merge_gpm_partition_idx | 0 | 1 | 2 | 3 | 4 | 5 | 6 | 7 |
|---|---|---|---|---|---|---|---|---|
| angleIdx | 0 | 0 | 2 | 2 | 2 | 2 | 3 | 3 |
| distanceIdx | 1 | 3 | 0 | 1 | 2 | 3 | 0 | 1 |
| merge_gpm_partition_idx | 8 | 9 | 10 | 11 | 12 | 13 | 14 | 15 |
| angleIdx | 3 | 3 | 4 | 4 | 4 | 4 | 5 | 5 |
| distanceIdx | 2 | 3 | 0 | 1 | 2 | 3 | 0 | 1 |
| merge_gpm_partition_idx | 16 | 17 | 18 | 19 | 20 | 21 | 22 | 23 |
| angleIdx | 5 | 5 | 8 | 8 | 11 | 11 | 11 | 11 |
| distanceIdx | 2 | 3 | 1 | 3 | 0 | 1 | 2 | 3 |
| merge_gpm_partition_idx | 24 | 25 | 26 | 27 | 28 | 29 | 30 | 31 |
| angleIdx | 12 | 12 | 12 | 12 | 13 | 13 | 13 | 13 |
| distanceIdx | 0 | 1 | 2 | 3 | 0 | 1 | 2 | 3 |
| merge_gpm_partition_idx | 32 | 33 | 34 | 35 | 36 | 37 | 38 | 39 |
| angleIdx | 14 | 14 | 14 | 14 | 16 | 16 | 18 | 18 |
| distanceIdx | 0 | 1 | 2 | 3 | 1 | 3 | 1 | 2 |
| merge_gpm_partition_idx | 40 | 41 | 42 | 43 | 44 | 45 | 46 | 47 |
| angleIdx | 18 | 19 | 19 | 19 | 20 | 20 | 20 | 21 |
| distanceIdx | 3 | 1 | 2 | 3 | 1 | 2 | 3 | 1 |
| merge_gpm_partition_idx | 48 | 49 | 50 | 51 | 52 | 53 | 54 | 55 |
| angleIdx | 21 | 21 | 24 | 24 | 27 | 27 | 27 | 28 |
| distanceIdx | 2 | 3 | 1 | 3 | 1 | 2 | 3 | 1 |
| merge_gpm_partition_idx | 56 | 57 | 58 | 59 | 60 | 61 | 62 | 63 |
| angleIdx | 28 | 28 | 29 | 29 | 29 | 30 | 30 | 30 |
| distanceIdx | 2 | 3 | 1 | 2 | 3 | 1 | 2 | 3 |

The index distanceIdx derived from the example in FIG. 7B is a value excluding the size of the current block. Therefore, the actual distance between the pixels in the current block and the straight line may be calculated by using the size information of the current block, the index angleIdx representing the angle, and the index distanceIdx representing the distance. Here, the actual distance is a value expressed in pixel units.

Meanwhile, the actual distance may be used to calculate the weight of each pixel in the current block. For example, for a single pixel in the first block partition, as the actual distance between the pixel and the straight line increases, the weight of the predictor of the first block partition, as described above, increases, and the weight of the predictor of the second block partition decreases. For pixels located on the partitioning boundary, the two predictors may use weights with the same value. In this case, the sum of the weights of the two predictors for a single pixel is maintained at 1.

On the two different block partitions of the current block existing within the current picture, the video decoding apparatus performs prediction by using each motion vector (mv0 or mv1). The video decoding apparatus applies a weight-based blending process to the prediction block of the first block partition and the prediction block of the second block partition to generate the final prediction block of the current block.

To perform inter prediction of the current block, the video decoding apparatus obtains a first prediction block by using the motion vector of the first block partition and obtains a second prediction block by using the motion vector of the second block partition. At this time, the video decoding apparatus may obtain the prediction block as multiplied by different weights according to the pixel position, as described above, in the process of obtaining the prediction block for each block partition. In addition, the video decoding apparatus may use shift operation and clipping operation in the process of generating the final prediction block from the prediction blocks multiplied by weights.

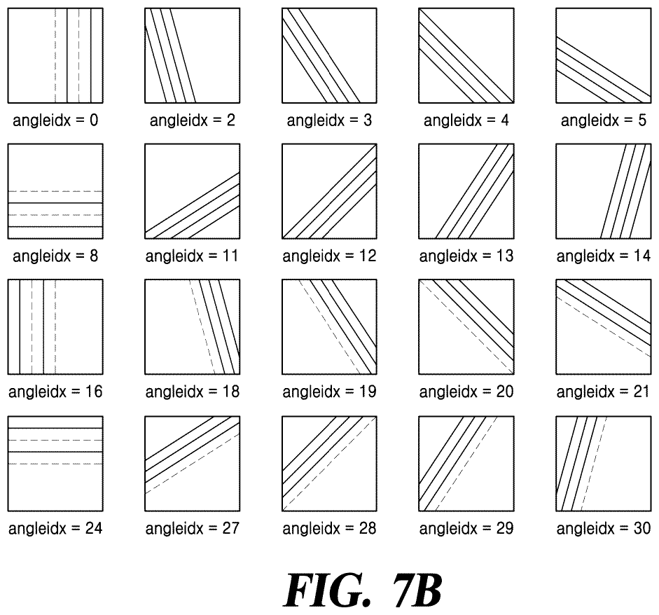

FIG. 8 is a diagram illustrating a geometric partitioning mode (GPM) merge list used for geometric motion prediction.

The video decoding apparatus, as illustrated in FIG. 8, selects motion information for motion prediction from the merge list and then uses the selected motion information.

However, unlike existing block-wise motion prediction techniques, for geometric motion prediction, the video decoding apparatus performs unidirectional prediction on a single block partition by limiting the prediction direction, as shown in FIG. 8. This is because, compared to block-wise motion prediction, in geometric motion prediction, when performing motion prediction by bi-prediction for each block partition, the memory bandwidth used for prediction can be twofold. Therefore, to efficiently address the above-described memory bandwidth increase issue, a technique that limits the directionality of prediction for each block partition may be applied.

In the case where the directionality of prediction is restricted for each block partition in geometric motion prediction, a GPM merge list for geometric motion prediction may be generated by using the existing merge list. To generate the GPM merge list, the video decoding apparatus first constructs the merge list as described above. Then, the video decoding apparatus may generate a GPM merge list for geometric motion prediction by the prediction directionality and the order within the list. At this point, the video decoding apparatus adds L0-direction motion information to the GPM merge list to generate merge candidates for geometric motion prediction of the first block partition. In addition, the video decoding apparatus may add L1-direction motion information to the GPM merge list to generate merge candidates for geometric motion prediction of the second block partition. In other words, the video decoding apparatus may derive unidirectional motion information of one direction from the existing bidirectional motion information and may add the derived motion information to the GPM merge list.

As shown in FIG. 8, in the existing geometric motion prediction method, the video decoding apparatus may use the merge candidate in the GPM merge list directly as motion information for motion prediction of the first block partition and the second block partition. Meanwhile, the video decoding apparatus may derive motion information related to GPM in a manner similar to that described above even in the AMVP mode of inter prediction.

In the GPM of the enhanced compression model (ECM) corresponding to beyond VVC, the video decoding apparatus generates, between the two partitioned blocks, predicted signals of one region by using motion compensation and predicted signals of another region by using intra prediction, and then weighted-sums the predicted signals of the two partitioned blocks to generate final predicted signals. This GPM is referred to as intra GPM. As described above, the two partitioned blocks are defined as the first partitioned block and the second partitioned block, respectively. The video decoding apparatus parses whether intra prediction is applied to the first partitioned block, and when intra prediction is not applied to the first partitioned block, it parses whether intra prediction is applied to the second partitioned block. On the other hand, when intra prediction is applied to the first partitioned block, the video decoding apparatus generates predicted signals of the second partitioned block by using motion compensation.

In ECM, GPM may apply MMVD to each partitioned block (gpm_mmvd) and apply motion information refinement based on template matching (TM) (gpm_tm). At this time, the video decoding apparatus may apply either gpm_mmvd or gpm_tm to a single coding unit (CU).

### II. Local Illumination Compensation (LIC)

When generating predicted signals of the current block by using motion compensation by inter prediction, local or global illumination changes may occur between the current frame and the reference frame. Local illumination compensation (LIC) is a technique that can improve prediction efficiency for the current block by performing illumination compensation according to changes in the image capturing environment.

To effectively perform local illumination compensation, the video decoding apparatus derives parameters representing the linear relational equation between the neighboring L-shaped template of the current block and the neighboring L-shaped template of the reference block. For example, the parameters of the linear relational equation may be derived based on the linear least squares method. At this time, the neighboring L-shaped template of the current block exists in the reconstructed region of the current block. The video decoding apparatus uses the derived parameters of the linear relational equation to perform local illumination compensation of the current block based on the reference block, as shown in Equation 1.

P′(x,y)=α×P(x,y)+β [Equation 1]

In Equation 1, α and β are parameters of the linear relational equation, representing the slope and offset, respectively. P(x,y) represents a pixel in the reference block, i.e., a predicted pixel, and P′(x,y) represents a predicted pixel in the current block subjected to local illumination compensation.

As mentioned above, local illumination compensation is applied to the current block, and the linear relational equation is derived based on the neighboring reference pixels adjacent to the reference block and the neighboring reference pixels adjacent to the current block. In this case, when there are no available pixels among the neighboring reference pixels of the reference block, local illumination compensation may not be performed for the current block. When available pixels exist not on both the left and top sides of the reference block but on a portion of the left and top sides, local illumination compensation may be performed by using some existing pixels.

The parameters α and β of the linear relational equation used in local illumination compensation are calculated identically in the video encoding apparatus and the video decoding apparatus. Therefore, the video encoding apparatus may not separately transmit the parameters of the linear relational equation to the video decoding apparatus.

When LIC is applied to a neighboring block selected according to the merge index in merge mode, the video decoding apparatus performs LIC by applying the LIC parameters of the neighboring block to the current block. In AMVP mode, a flag indicating whether LIC is to be performed is signaled, and the video decoding apparatus derives the LIC parameters by using the template of the current block and the template of the reference block.

Additionally, LIC is applied in the case of unidirectional prediction, and LIC is not applied when the current block is predicted according to Combined Inter Intra Prediction (CIIP). CIIP is a technique that generates blocks after intra prediction, which are intra-prediction blocks and blocks after inter prediction, which are inter-prediction blocks to the current block, and then weighted-sums the intra-prediction blocks and inter-prediction blocks to generate the final prediction block of the current block.

Additionally, LIC may be applied to bi-prediction blocks. When LIC is applied to a neighboring block selected according to the merge index in merge mode, the video decoding apparatus performs LIC by applying the LIC parameters of the neighboring block to the current block. In AMVP mode, a flag indicating whether LIC is to be performed is signaled, and the video decoding apparatus derives the LIC parameters by using the template of the current block and the template of the reference block. Additionally, when bi-directional optical flow (BDOF) and decoder-side motion vector refinement (DMVR) are performed, LIC is not applied. BDOF is a method of refining bidirectional motion information by using OF, and DMVR is a method of refining motion information based on Bi-lateral Matching (BM). When overlapped block motion compensation (OBMC) is performed and LIC is applied to the neighboring blocks of the current block, the video decoding apparatus performs OBMC on the current block by using the LIC parameters of the neighboring blocks. OBMC is a technique that blends the prediction block based on the original motion information and the prediction block based on the motion information of the neighboring blocks to generate the final prediction block.

When bidirectional LIC is applied, the video decoding apparatus generates the final predicted signals P′ according to Equation 2.

$${P}^{′} ( x , y ) = ( 1 - w ) \times {P}_{0}^{′} ( x , y ) + w \times {P}_{1}^{′} ( x , y ) \qquad [ Equation 2 ]$$

In Equation 2, w may be calculated by using BCW_idx signaled at the CU level. Here, bi-prediction with CU-level weight (BCW) represents the weight for summing bidirectional prediction blocks. P₀′ denotes the L0 prediction block with local illumination compensation applied, and P₁′ denotes the L1 prediction block with local illumination compensation applied. At this point, P₀′ (x,y) and P₁′ (x,y) may be generated by using the following iterative method.

The template of the current block is defined as T, the template of the L0 prediction block as T₀, and the template of the L1 prediction block as T₁. The video decoding apparatus derives parameters α₀ and β₀ that express the relationship between T and T₀ as a linear model as in Equation 3.

T(x,y)=α₀×T₀(x,y)+β₀ [Equation 3]

The template of the reinforced current block according to Equation 3 is defined as T′, and the video decoding apparatus derives parameters α₁ and β₁ that express the relationship between T′ and T₁ as a linear model as in Equation 4.

T′(x,y)=α₁×T₁(x,y)+β₁ [Equation 4]

The template of the reinforced current block according to Equation 4 is defined as T″, and the video decoding apparatus refines α₀ and β₀ by expressing the relationship between T″ and T₀ as a linear model as in Equation 5.

$${T}^{″} ( x , y ) = {α}_{0}^{′} \times {T}_{0} ( x , y ) + {β}_{0}^{′} \qquad [ Equation 5 ]$$

By using α₀′, β₀′, α₁, and β₁ according to Equations 4 and 5, the video decoding apparatus calculates P₀′ (x,y) and P₁′ (x,y) and generates the final predicted signals of the current block according to Equation 2.

The following embodiments are described with a focus on the video decoding apparatus, but they may be implemented in the same or similar manner in the video encoding apparatus.

### III. Embodiments According to the Present Disclosure

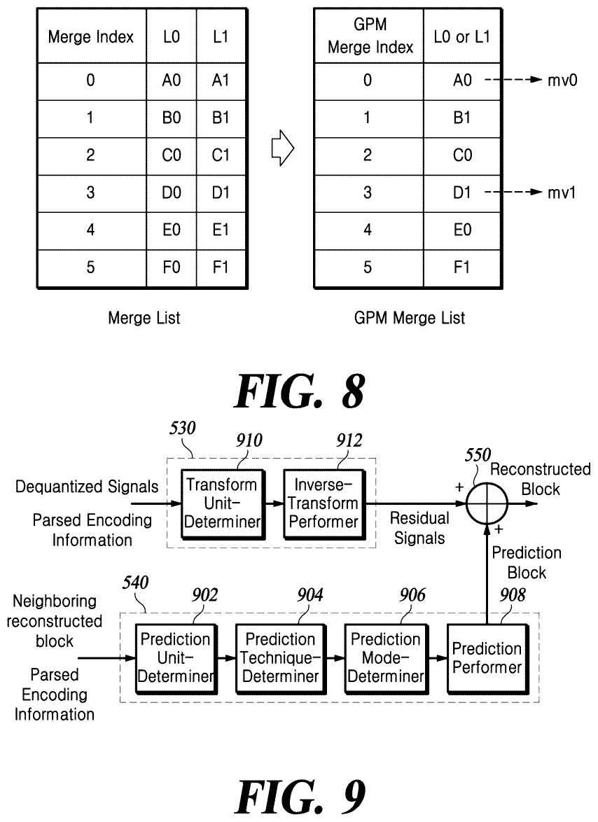

The video decoding apparatus according to some embodiments may determine prediction and transform units, and in response to a current block corresponding to the determined unit, may perform a prediction and an inverse transform by using a determined prediction technique and prediction mode, to finally generate a reconstructed block of the current block. The operations illustrated in FIG. 9 may be performed by the inverse transformer 530, the predictor 540, and the adder 550 of the video decoding apparatus. On the other hand, the same operations as illustrated in FIG. 9 may be performed by the inverse transformer 165, the picture splitter 110, the predictor 120, and the adder 170 of the video encoding apparatus. In this case, the video decoding apparatus uses encoding information parsed from the bitstream, but the video encoding apparatus may use encoding information set from a high level in terms of minimizing bit rate distortion. Hereinafter, for convenience, the embodiments are described centering on the video decoding apparatus.

As illustrated in FIG. 5, the predictor 540 includes the intra predictor 542 and the inter predictor 544, depending on the prediction technique, but as illustrated in FIG. 9, the predictor 540 may include all or part of a prediction unit-determiner 902, a prediction technique-determiner 904, a prediction mode-determiner 906, and a prediction performer 908.

When the color format of the input video is a YUV format (YUV420, YUV411, YUV422, YUV444, or the like), the video decoding apparatus may perform prediction and reconstruction of the luma component, and then may perform prediction and reconstruction of the chroma component. In this way, the luma component and the chroma component may be sequentially reconstructed by the components illustrated in FIG. 9. On the other hand, when the color format of the input video is RGB, the video encoding apparatus may perform a color format conversion from RGB to YUV, and then may encode the converted video. Here, in the YUV format, the color format represents a correspondence between pixels in the luma component and pixels in the chroma component.

The prediction unit-determiner 902 determines a prediction unit (PU). The prediction technique-determiner 904, in response to the prediction unit, determines a prediction technique, e.g., intra prediction, inter prediction, or intra block copy (IBC) mode, palette mode, or the like. The prediction mode-determiner 906 determines a detailed prediction mode for the prediction technique. The prediction performer 908 generates a prediction block of the current block according to the determined prediction mode.

The inverse transformer 530 includes a transform unit-determiner 910 and an inverse transform performer 912. The transform unit-determiner 910 determines a transform unit (TU) in response to the dequantized signals of the current block, and the inverse transform performer 912 inversely transforms the transform unit represented by the dequantized signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 902 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed in response to the prediction unit of the chroma component. The prediction technique-determiner 904 determines a prediction technique for the prediction units. As described above, the prediction technique may be one of inter prediction, intra prediction, IBC mode, and palette mode. In this case, the prediction technique for the chroma component may be determined to be the same as the prediction technique of the corresponding luma component without signaling and parsing any additional information.

In one example, when the prediction technique of the current block is not intra prediction, the video decoding apparatus parses the 1-bit flag information. When the parsed flag indicates a skip mode, the video decoding apparatus may determine the prediction mode of the current block to be an inter prediction merge mode or an IBC merge mode. In the skip mode, the video decoding apparatus may also use the predicted signals in place of reconstructed signals, while skipping an inverse transform, i.e., without parsing residual signals.

On the other hand, when the parsed flag does not indicate a skip mode in response to the current block, the prediction technique-determiner 904 may determine one of the prediction techniques, such as inter prediction, intra prediction, IBC mode, palette mode, or the like, by parsing a series of 1-bit flags to be the prediction technique of the current block.

For example, when skip mode is not applied to the current block and the inter prediction or IBC mode is determined to be the prediction technique, the video decoding apparatus parses a 1-bit flag. The video decoding apparatus may determine, based on the parsed flag, the prediction mode of the current block to be the regular merge mode or AMVP (advanced motion vector prediction) mode.

The prediction mode-determiner 906 determines a detailed prediction mode for the prediction technique.

As an example, when the prediction technique of the current block is inter prediction, the prediction mode-determiner 906 may determine the regular merge mode or AMVP mode as the prediction mode of the current block. In the regular merge mode or AMVP mode, the video decoding apparatus generates prediction blocks based on one or more motion compensations based on the parsed motion information, and weighted-sums the multiple generated prediction blocks to generate the final predicted signals of the current block.

In another example, when the prediction technique for the current block is inter prediction, the prediction mode-determiner 906 may determine the geometric partitioning mode (GPM) as the prediction mode of the current block. In GPM, the video decoding apparatus divides the current block into two or more partitioned blocks according to the geometric partition, generates prediction blocks by one or more motion compensations based on the motion information of the parsed current block, and weighted-sums the multiple generated prediction blocks to generate the final predicted signals of the current block. For example, as described above, the current block may be divided into two partitioned blocks.

The prediction performer 908 generates the prediction block of the current block according to the determined prediction technique and prediction mode.

As an example, the prediction performer 908 generates the prediction block of the current block according to the prediction mode, and the adder 550 sums the current block's prediction block and the residual signals to generate the reconstructed block.

Meanwhile, the entropy decoder 510 when subjected to a secondary transform may reconstruct the quantized secondary transform coefficients. On the other hand, with no secondary transform applied, the entropy decoder 510 may reconstruct the quantized primary transform coefficients. The inverse quantizer 520 may apply inverse quantization to the transform coefficients reconstructed based on the quantization parameters to generate inverse quantized transform coefficients.

The transform unit-determiner 910 of the inverse transformer 530 determines the transform unit (TU) for the inverse quantized transform coefficients. At this time, when a single TU is divided into multiple subblocks, a single subblock may be used as a TU.

The inverse transformer 530 when subjected to a secondary transform may determine a non-separable secondary inverse transform kernel and a separable primary inverse transform kernel. On the other hand, with no secondary transform applied, the inverse transformer 530 may determine a separable primary inverse transform kernel or a non-separable primary inverse transform kernel.

The following description interchangeably uses geometric partitioning mode, GPM partitioning mode, and partitioning mode according to GPM.

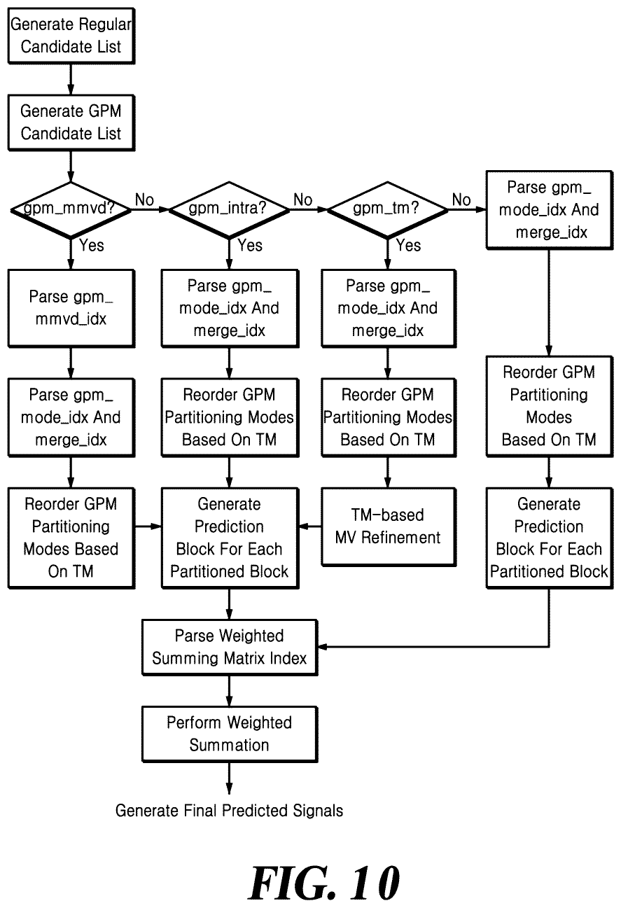

FIG. 10 is a flowchart of the operation of a prediction performer, according to at least one embodiment of the present disclosure.

The following describes in detail the operation of the prediction performer 908 in the video decoding apparatus according to the present disclosure. As an example, when the prediction technique for the current block is inter prediction and the current block is predicted according to GPM, the current block may be predicted according to the sequence illustrated in FIG. 10.

When the current block is predicted according to GPM, the video decoding apparatus generates and uses a regular motion vector candidate list to generate a GPM (motion vector) candidate list. The GPM candidate list may be the GPM merge list shown in FIG. 8. Alternatively, the GPM candidate list may be a list including candidates having bidirectional motion information.

The video decoding apparatus checks whether gpm_mmvd is applied. When gpm_mmvd is not applied, the video decoding apparatus checks whether intra GPM, i.e., gpm_intra, is applied. When gpm_intra is not applied, the video decoding apparatus checks whether gpm_tm is applied.

When gpm_mmvd is applied, the video decoding apparatus decodes gpm_mmvd_idx, gpm_mode_idx, and merge_idx. After reordering the GPM partitioning modes based on TM, the video decoding apparatus determines the geometric partitioning mode according to gpm_mode_idx and determines the motion information predictor of the partitioned blocks by using merge_idx and the GPM candidate list. Here, the TM-based reordering of GPM partitioning modes involves calculating the TM cost for the 64 partitioning modes according to Table 1 and reordering the GPM partitioning modes according to the calculated cost. Therefore, gpm_mode_idx indicates one of the reordered partitioning modes. The video decoding apparatus generates a motion information difference according to gpm_mmvd_idx and sums the motion information difference and the motion information predictor to generate motion information. As mentioned above, gpm_mmvd_idx may include a distance index and a direction index. The video decoding apparatus uses the motion information to generate prediction blocks of partitioned blocks. The video decoding apparatus decodes the weighted-summing matrix index for blending, and then uses the weighted-summing matrix corresponding to the weighted-summing matrix index to blend the prediction blocks of partitioned blocks, thereby generating the final predicted signals of the current block. Here, the GPM index gpm_mode_idx may be merge_gpm_partition_idx according to Table 1 and indicates one of the GPM partition modes. The merge index merge_index may indicate a motion information predictor within the GPM candidate list.

When gpm_intra is applied, the video decoding apparatus decodes gpm_mode_idx and merge_idx. After performing TM-based reordering of the partitioning modes according to GPM, the video decoding apparatus determines the geometric partitioning mode according to gpm_mode_idx and uses merge_idx and the GPM candidate list to determine the motion information of the partitioned block subjected to inter prediction. The video decoding apparatus uses the motion information to generate a prediction block of a partitioned block subjected to inter prediction. In addition, the video decoding apparatus generates a prediction block of a partitioned block subjected to intra prediction. The video decoding apparatus decodes the weighted-summing matrix index for blending, and then uses the weighted-summing matrix according to the weighted-summing matrix index to blend the prediction block of the inter-predicted partitioned block and the prediction block of the intra-predicted partitioned block, thereby generating the final predicted signals of the current block.

When gpm_tm is applied, the video decoding apparatus decodes gpm_mode_idx and merge_idx. After performing TM-based reordering of the partitioning modes according to GPM, the video decoding apparatus determines the geometric partitioning mode according to gpm_mode_idx and uses merge_idx and the GPM candidate list to determine the motion information of the partitioned blocks. The video decoding apparatus refines the motion information, e.g., motion vector (MV) based on TM. The video decoding apparatus uses the refined motion information to generate prediction blocks of the partitioned blocks. The video decoding apparatus decodes the weighted-summing matrix index for blending, and then uses the weighted-summing matrix according to the weighted-summing matrix index to blend the prediction blocks of the partitioned blocks, thereby generating the final predicted signals of the current block.

If none of gpm_mmvd, gpm_intra, and gpm_tm are applied, the video decoding apparatus decodes gpm_mode_idx and merge_idx. After performing TM-based reordering of the partitioning modes according to GPM, the video decoding apparatus determines the geometric partitioning mode according to gpm_mode_idx and uses merge_idx and the GPM candidate list to determine the motion information of the partitioned blocks. The video decoding apparatus uses the motion information to generate prediction blocks of the partitioned blocks. The video decoding apparatus decodes the weighted-summing matrix index for blending, and then uses the weighted-summing matrix according to the weighted-summing matrix index to blend the prediction blocks of the partitioned blocks, thereby generating the final predicted signals of the current block.

The above describes the case where the prediction mode is the merge mode, but it may also be similarly applied when GPM is applied in the AMVP mode.

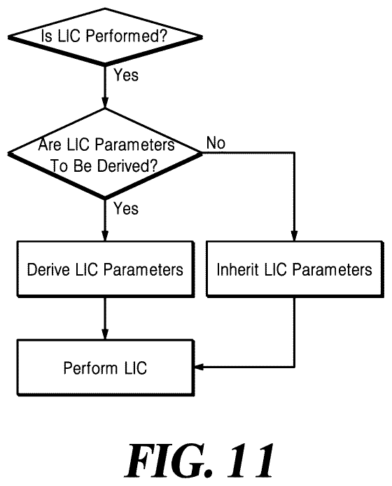

FIG. 11 is a flowchart of a method of performing local illumination compensation, according to at least one embodiment of the present disclosure.

As an example, following the sequence illustrated in FIG. 11, the video decoding apparatus may apply LIC to the current block. When the LIC is applied, depending on whether LIC parameters are to be derived, the video decoding apparatus may derive LIC parameters or inherit LIC parameters, for example, from neighboring blocks. The video decoding apparatus uses the LIC parameters to perform LIC on the current block.

In another example, when the current block is predicted according to GPM, the video decoding apparatus may parse gpm_mode_idx and merge_idx, and then may apply LIC to the partitioned block subjected to motion compensation. By signaling a 1-bit flag for each partitioned block, the application or non-application of LIC may be determined. Alternatively, when LIC is implicitly applied to a reconstructed block neighboring the current block, LIC may be applied to the partitioned block of the current block. As mentioned above, gpm_mode_idx is an index indicating the GPM partitioning mode of the current block, and merge_idx is an index of the motion information of the partitioned block subjected to motion compensation. For example, merge_idx_0 and merge_idx_1 may be used for the first partitioned block and the second partitioned block of the current block, respectively.

Hereinafter, the partitioned block subjected to motion compensation is referred to as the inter-partitioned block.

Hereinafter, the inheritance and derivation of LIC parameters are described.

An example case is where the current block is predicted according to the geometric partitioning mode, and only one of the two partitioned blocks generates a prediction block according to motion compensation, i.e., the case where there is only one inter-partitioned block.

As an example, when the neighboring block providing motion information according to merge_idx has used LIC in the prediction process, the video decoding apparatus may inherit and use the LIC parameters α and β of the neighboring block.

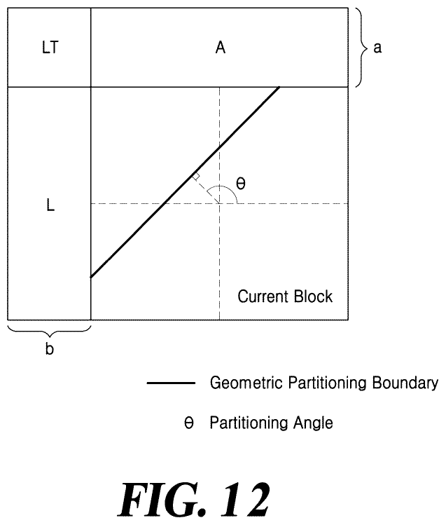

For the inheritance/derivation of LIC parameters, the templates of the respective partitioned blocks are defined according to the angle index angleIdx, as illustrated in FIG. 12 and Table 2.

TABLE 2

| angleIdx | 0 | 2 | 3 | 4 | 5 | 8 | 11 | 12 | 13 | 14 |
|---|---|---|---|---|---|---|---|---|---|---|
| First Partitioned Block | A | A | A | A | L + A | L + A | L + A | L + A | A | A |
| Second Partitioned Block | L + A | L + A | L + A | L | L | L | L | L + A | L + A | L + A |
| angleIdx | 16 | 18 | 19 | 20 | 21 | 24 | 27 | 28 | 29 | 30 |
| First Partitioned Block | A | A | A | A | L + A | L + A | L + A | L + A | A | A |
| Second Partitioned Block | L + A | L + A | L + A | L | L | L | L | L + A | L + A | L + A |

In the example of FIG. 12, ‘a’ and ‘b’ represent positive integers. A represents the top template above the current block, L represents the left template of the current block, and LT represents the top-left corner of the current block. In Table 2, L+A represents the top-left template of the current block, i.e., the L-shaped template.

In an example case, the neighboring block providing motion information according to merge_idx may use LIC in the prediction process, and the same neighboring block may be located within the template of the inter-partitioned block subjected to motion compensation. In that case, the video decoding apparatus may inherit the LIC parameters α and β of the block.

In another example, the neighboring block providing motion information according to merge_idx may use LIC in the prediction process, and the same neighboring block is located within the template of a partitioned block subjected to motion compensation. In that case, the video decoding apparatus may derive the LIC parameters α and β by using the current partitioned block's, i.e., the inter-partitioned block's template, and the template of the reference block according to the motion information. At this time, when motion information is obtained from the LT position in the example of FIG. 12, the video decoding apparatus may use the L+A template to derive the LIC parameters α and β.

For example, the video decoding apparatus may derive the LIC parameters according to the least squares method, such as Equations 6 and 7.

$$α = \frac{N \times \sum ( C ( n ) \times R ( n ) ) - \sum ( C ( n ) ) \times \sum ( R ( n ) )}{N \times \sum ( C ( n ) \times C ( n ) ) - \sum ( C ( n ) ) \times \sum ( C ( n ) )} \qquad [ Equation 6 ]$$

$$β = \frac{\sum R ( n ) - α \times \sum C ( n )}{N \times \sum ( C ( n ) \times C ( n ) ) - \sum ( C ( n ) ) \times \sum ( C ( n ) )} \qquad [ Equation 7 ]$$

In Equation 6 and Equation 7, C(n) is the pixel value within the current partitioned block's template used to derive the LIC parameters, and R(n) is the pixel value within the reference block's template used to derive the LIC parameters. N represents the number of pixels used to derive the LIC parameters.

As yet another example, the video decoding apparatus may derive LIC parameters according to Equation 8 and Equation 9.

$$α = \frac{{C}_{max} - {C}_{min}}{{R}_{max} - {R}_{min}} \qquad [ Equation 8 ]$$

β=Cₘᵢₙ−α×Rₘᵢₙ [Equation 9]

In Equation 8 and Equation 9, Cₘₐₓ and Cₘᵢₙ represent the maximum and minimum values within the template of the current partitioned block, respectively, and Rₘₐₓ and Rₘᵢₙ represent the maximum and minimum values within the template of the reference block, respectively.

For example, the video decoding apparatus may derive LIC parameters by using all pixels within the template of the current partitioned block or reference block. Alternatively, the video decoding apparatus may sample s samples (where s is a positive integer) within the template and uses some of the sampled pixels to derive LIC parameters. As an example, when performing sampling, the video decoding apparatus may apply different sampling rates to the top template and the left template of the current partitioned block.

As an example, when bi-prediction is applied to the current partitioned block, the LIC parameters may be derived by using the following iterative method. Here, the current partitioned block corresponding to the inter-partitioned block may be either the first partitioned block or the second partitioned block. The template of the current partitioned block is defined as T, the template of the L0 reference block of the same shape is defined as T₀, and the template of the L1 reference block of the same shape is defined as _{T1}. The video decoding apparatus derives parameters α₀ and β₀ that express the relationship between T and T₀ as a linear model, as shown in Equation 10.

T(x,y)=α₀×T₀(x,y)+β₀ [Equation 10]

Defined as T′ is the current partitioned block's enhanced template according to Equation 10, and the video decoding apparatus derives parameters α₁ and β₁ that express the relationship between T′ and T₁ as a linear model according to Equation 11.

T′(x,y)=α₁×T₁(x,y)+β₁ [Equation 11]

Defined as T″ is the current partitioned block's enhanced template according to Equation 11, and the video decoding apparatus refines α₀ and β₀ by expressing T″ and T₀ as a linear model according to Equation 12.

T″(x,y)=α₀′×T₀(x,y)+β₀′ [Equation 12]

By using α₀′, β₀′, α₁, and β₁ according to Equation 11 and Equation 12, the video decoding apparatus calculates P₀′(x,y) and P₁′(x,y) with local illumination compensation applied, and generates the final predicted signals P′ of the current partitioned block according to Equation 13.

$${P}^{′} ( x , y ) = ( 1 - w ) \times {P}_{0}^{′} ( x , y ) + w \times {P}_{1}^{′} ( x , y ) \qquad [ Equation 13 ]$$

In Equation 13, w may be calculated based on the BCW_idx of the neighboring blocks of the current block. At this time, the aspect ratio of the current block or a fixed value may be used as w.

As another example, when bi-prediction is applied to the current partitioned block, the LIC parameters may be derived according to the following iterative method. The template of the current partitioned block is defined as T, the template of the L0 prediction block of the same shape as T₀, and the template of the L1 prediction block of the same shape as T₁. The video decoding apparatus derives parameters α₁ and β₁ that represent a linear model between T and T₁, as shown in Equation 14.

T(x,y)=α₁×T₁(x,y)+β₁ [Equation 14]

The current partitioned block's enhanced template according to Equation 14 is defined as T′, and the video decoding apparatus derives parameters α₀ and β₀ that represent a linear model between T′ and T₀ as shown in Equation 11.

T′(x,y)=α₀×T₀(x,y)+β₀ [Equation 15]

Defined as T″ is the current partitioned block's reinforced template according to Equation 15, and the video decoding apparatus refines α₁ and β₁ by expressing T″ and T₁ as a linear model as shown in Equation 16.

T″(x,y)=α₁′×T₁(x,y)+β₁′ [Equation 16]

By using α₀, β₀, α₁′, and β₁′ according to Equations 15 and 16, the video decoding apparatus calculates P₀′ (x,y) and P₁′ (x,y) with local illumination compensation applied, and generates the final predicted signals of the current partitioned block according to Equation 13. As mentioned above, in Equation 13, w may be calculated based on the BCW_idx of the neighboring blocks of the current block. At this time, w may be the aspect ratio of the current block or a fixed value.

As another example, when bi-prediction is applied to the current partitioned block, the LIC parameters may be derived as follows. The template of the current partitioned block is defined as T, the template of the L0 prediction block of the same shape as T₀, and the template of the L1 prediction block of the same shape as T₁. Then, the video decoding apparatus weighted-sums T₀ and T₁ according to Equation 17 to generate a new template T01.

T₀₁(x,y)=k×T₀(x,y)+(1−k)×T₁(x,y) [Equation 17]

In Equation 17, k may be a predefined value. Alternatively, k may be derived based on the picture order count (POC) difference between the current frame and the reference frame. Alternatively, the video decoding apparatus may apply weighted-summing to a portion of the template rather than applying weighted-summing to the entire template.

The video decoding apparatus may calculate the LIC parameters between T₀₁ and T according to Equation 6 and Equation 7. Alternatively, the video decoding apparatus may calculate the LIC parameters between T₀₁ and T according to Equation 8 and Equation 9. The video decoding apparatus may apply weighted-summing to the prediction blocks to generate a single prediction block, and apply the LIC parameters to the weighted-summed prediction block to generate the final predicted signals of the current partitioned block. In this case, the weighted-summing of the prediction blocks may be performed in the same manner as in Equation 17.

As an example, when the current block is predicted according to GPM and bi-prediction is possibly applied to each partitioned block, the video decoding apparatus may omit the step of constructing a GPM (motion vector) candidate list as shown in FIG. 10.

As an example, with regard to the template of the current partitioned block defined in FIG. 12, when the neighboring block is not located within the template of the partitioned block subjected to motion compensation, the video decoding apparatus may not apply LIC to the latter partitioned block.

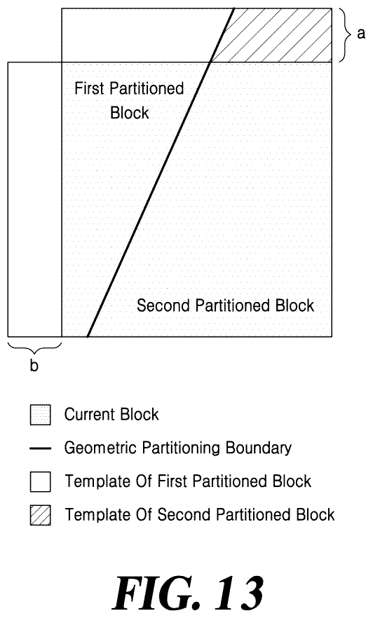

As an example, the video decoding apparatus may extend the geometric partitioning boundary of the current block to the template of the current block, as illustrated in FIG. 13, and then define a template for each partitioned block according to the extended partitioning boundary. In the example of FIG. 13, ‘a’ and ‘b’ are positive integers.

Furthermore, when the neighboring blocks providing motion information according to merge_idx has used LIC in the prediction process, the video decoding apparatus may apply LIC to the current partitioned block as follows.

When the above neighboring block is located within the template of the partitioned block subjected to motion compensation, the video decoding apparatus may inherit the LIC parameters α and β of the block.

When the above neighboring block is located within the template of the partitioned block subjected to motion compensation, the video decoding apparatus may use the template of the partitioned block subjected to motion compensation and the same-shaped template of the same-shaped reference block obtained from the motion information. For example, the video decoding apparatus may derive LIC parameters between templates according to Equation 6 and Equation 7. Alternatively, the video decoding apparatus may derive LIC parameters between templates according to Equation 8 and Equation 9.

When the above neighboring block is not located within the template of the partitioned block subjected to motion compensation, the video decoding apparatus may not apply LIC to the partitioned block.

As an example, to perform LIC as described above, the video decoding apparatus may perform a redundancy check between the neighboring reconstructed blocks of the current block when constructing the motion vector candidate list of the current block according to the example in FIG. 8, thereby preventing redundant candidates from being included in the candidate list.

The above describes a case where the current block is predicted in geometric partitioning mode and only one of the two partitioned blocks generates a prediction block according to motion compensation. Another example describes a case where the current block is predicted in geometric partitioning mode and both partitioned blocks generate prediction blocks according to motion compensation.

As an example, when LIC is applied only to the first partitioned block, the video decoding apparatus may inherit or derive the LIC parameters α₀ and β₀ of the first partitioned block according to the above-described process, which is inheriting/deriving LIC parameters when only one of the two partitioned blocks generates a prediction block according to motion compensation.

As another example, when LIC is applied only to the second partitioned block, the video decoding apparatus may inherit or derive the LIC parameters α₁ and β₁ of the second partitioned block according to the above-described process, which is inheriting/deriving LIC parameters when only one of the two partitioned blocks generates a prediction block according to motion compensation.

In yet another example, when LIC is applied to both the first partitioned block and the second partitioned block, the video decoding apparatus may inherit or derive the LIC parameters α₀ and β₀ of the first partitioned block and the LIC parameters α₁ and β₁ of the second partitioned block according to the above-described process, which is inheriting/deriving LIC parameters when only one of the two partitioned blocks generates a prediction block based on motion compensation.

As an example, when applying LIC to the first partitioned block or the second partitioned block, the video decoding apparatus may generate the final predicted signals of the current block as follows.

On the partitioned block to be subjected to LIC, the video decoding apparatus performs LIC according to Equation 18.

P′(x,y)=α×P(x,y)+β [Equation 18]

In Equation 18, P(x,y) represents the initial predicted signals, α and β represent the LIC parameters, and P′(x,y) represents the predicted signals with LIC applied. The video decoding apparatus may weighted-sum the two prediction blocks, i.e., the prediction block of the partitioned block with LIC applied, and the prediction block of the remaining partitioned block, to generate the final predicted signals of the current block.

As another example, when LIC is applied to both the first partitioned region and the second partitioned region, the video decoding apparatus may generate the final predicted signals of the current block as follows.

With the two partitioned blocks, the video decoding apparatus performs LIC on each of the two partitioned blocks according to Equation 18. Here, P(x,y) represents the initial predicted signals, α and β represent the LIC parameters, and P′(x,y) represents the predicted signals with LIC applied. The video decoding apparatus may weighted-sum the two prediction blocks, i.e., the prediction blocks of the two partitioned blocks with LIC applied, to generate the final predicted signals of the current block.

For example, when the LIC parameters of the first partitioned block and the LIC parameters of the second partitioned block are both inherited, the video decoding apparatus uses the inherited parameters to perform LIC on each of the two partitioned blocks. The video decoding apparatus may weighted-sum the two prediction blocks, i.e., the prediction blocks of the two partitioned blocks with LIC applied based on the inherited LIC parameters, to generate the final predicted signals of the current block.

As another example, the video decoding apparatus may first perform weighted-summing on the initial prediction blocks of the two partitioned blocks to generate the prediction block of the current block, and then perform LIC on the prediction block generated by the weighted-summation to generate the final predicted signals of the current block.

As an example shown in FIG. 13, based on the reference templates of the respective partitioned blocks and the neighboring templates around the current block, the video decoding apparatus may derive the LIC parameters according to Equation 6 and Equation 7. Alternatively, the video decoding apparatus may derive the LIC parameters according to Equation 8 and Equation 9. By using the derived LIC parameters, the video decoding apparatus may perform LIC on the prediction block generated by weighted-summation to generate the final predicted signals of the current block.

As another example, in the process of constructing the template and reference template of the current block for deriving LIC parameters, the video decoding apparatus does not perform weighted-summation for blending the templates of partitioned blocks. For example, the video decoding apparatus may generate the template of the first partitioned block and the template of the second partitioned block based on the partitioning boundary shown in FIG. 13. As described above, the video decoding apparatus first performs weighted-summing on the initial prediction blocks of the two partitioned blocks to generate the prediction block of the current block. However, to generate the reference template, the video decoding apparatus does not perform blending of the template of the initial prediction block of the first partitioned block and the template of the initial prediction block of the second partitioned block.

Hereinafter, the performing of LIC according to the TM-based reordering of GPM partitioning modes is described.

When the current block is predicted according to GPM and the TM-based reordering of GPM partitioning modes is performed, the video decoding apparatus may construct a template for each GPM partitioning mode by using the template defined in the example of FIG. 13 according to the GPM partitioning modes in Table 1. At this time, no weighted-summing is performed for blending between the templates of the partitioned blocks during the process of constructing the template of the current block and the reference template.

For example, when the partitioned blocks of the current block have a partitioned block to be subjected to LIC, the video decoding apparatus inherits the LIC parameters of the latter partitioned block from neighboring blocks. The video decoding apparatus may use the inherited LIC parameters to perform LIC on the template of the partitioned block and thereby construct the template of the current block.

For example, when the partitioned blocks of the current block have a partitioned block to be subjected to LIC, the video decoding apparatus may not perform LIC during the TM-based reordering process of GPM partitioning modes.

The following describes the performing of LIC according to TM-based MV refinement.

As an example, when the current block is predicted according to GPM and TM-based MV refinement is performed, the video decoding apparatus may calculate LIC parameters and then perform TM-based MV refinement. The video decoding apparatus may inherit LIC parameters from a neighboring block or may use the MV before refinement to derive LIC parameters.

As an example, when TM-based MV refinement is performed after calculating the LIC parameters, the video decoding apparatus may use the template processed with LIC, to perform TM-based MV refinement.

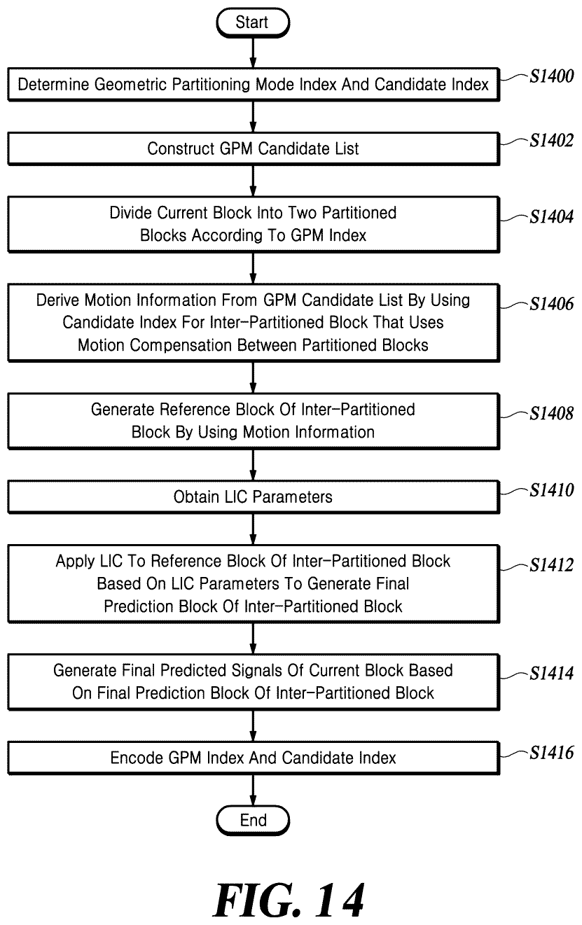

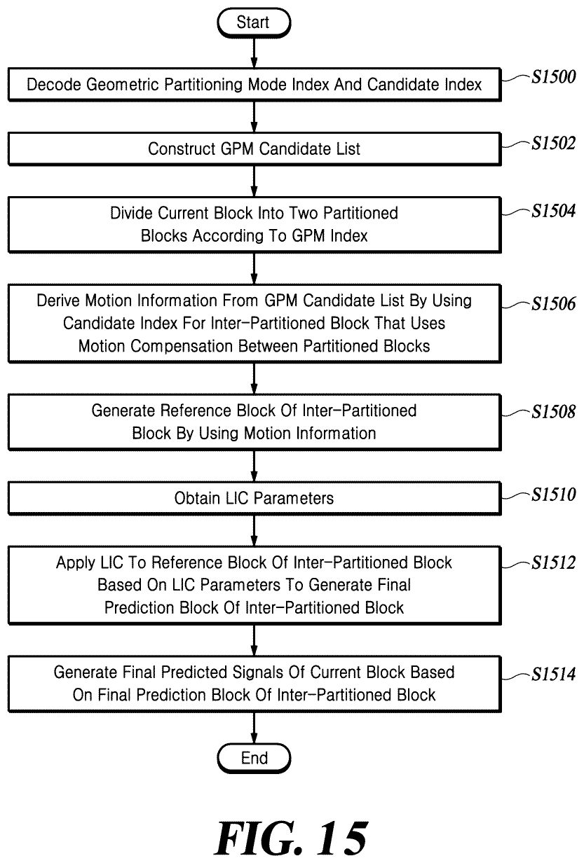

Hereinafter, by using the illustrations in FIGS. 14 and 15, methods of applying local illumination compensation (LIC) when the current block is predicted according to geometric partitioning mode (GPM) are described.

FIG. 14 is a flowchart of a method of encoding a current block by the video encoding apparatus, according to at least one embodiment of the present disclosure.

The video encoding apparatus determines a GPM index and a candidate index (S1400).

As illustrated in Table 1, the GPM index may use the angle index angleIdx and the distance index distanceIdx to determine the partitioning boundary according to the geometric partitioning mode.

The video encoding apparatus constructs a GPM candidate list (S1402).

The video encoding apparatus generates a regular motion vector candidate list, and then uses the regular motion vector candidate list to generate a GPM (motion vector) candidate list.

The video encoding apparatus divides the current block into two partitioned blocks according to the GPM index (S1404).

The video encoding apparatus derives motion information from the GPM candidate list by using the candidate index for the inter-partitioned block that uses motion compensation between the partitioned blocks (S1406).

Here, at least one inter-partitioned block exists between the partitioned blocks. When two inter-partitioned blocks exist, the video encoding apparatus may use separate candidate indices to derive motion information for each inter-partitioned block.

The video encoding apparatus uses the motion information to generate a reference block of the inter-partitioned block (S1408).

The video encoding apparatus obtains LIC parameters (S1410). Here, the LIC parameters define a linear relationship between the reference block and the inter-partitioned block with LIC applied.

For example, when the neighboring blocks providing motion information use LIC and a neighboring block is located within the template of the inter-partitioned block, the video encoding apparatus may inherit the LIC parameters from the neighboring block.

In another example, when the neighboring block providing motion information uses LIC and the neighboring block is located within the template of the inter-partitioned block, the video encoding apparatus may derive the LIC parameters by using the least squares method based on the pixel values within the template of the inter-partitioned block and the pixel values within the template of the reference block.

As yet another example, when the neighboring block providing motion information uses LIC, and the neighboring block is located within the template of the inter-partitioned block, the video encoding apparatus may derive LIC parameters by using the maximum pixel value and minimum pixel value within the template of the inter-partitioned block, and the maximum pixel value and minimum pixel value within the template of the reference block.

As an example, when bi-prediction is applied to the inter-partitioned block, the video encoding apparatus may use an iterative method based on the template of the inter-partitioned block, the template of the first reference block, and the template of the second reference block, to calculate first LIC parameters representing a linear relationship between the template of the inter-partitioned block and the template of the first reference block, and second LIC parameters representing a linear relationship between the template of the inter-partitioned block and the template of the second reference block.

As another example, when bi-prediction is applied to the inter-partitioned block, the video encoding apparatus may weighted-sum the template of the first reference block and the template of the second reference block to generate a reference template, and may use the template of the inter-partitioned block and the reference template to derive the LIC parameters.

The video encoding apparatus applies LIC to the reference block of the inter-partitioned block based on the LIC parameters, thereby generating the final prediction block of the inter-partitioned block (S1412).

As an example, when bi-prediction is applied to the inter-partitioned block, the video encoding apparatus applies LIC to the first reference block based on the first LIC parameters to generate the first prediction block of the inter-partitioned block, and applies LIC to the second reference block based on the second LIC parameters to generate the second prediction block of the inter-partitioned block. The video encoding apparatus may weighted-sum the first prediction block and the second prediction block to generate a final prediction block.

As another example, when bi-prediction is applied to an inter-partitioned block, the video encoding apparatus weighted-sums the first reference block and the second reference block to generate a prediction block of the inter-partitioned block. The video encoding apparatus may apply LIC to the prediction block of the inter-partitioned block based on the LIC parameters to generate a final prediction block.

The video encoding apparatus generates final predicted signals of the current block based on the final prediction block of the inter-partitioned block (S1414).

For example, when one of the partitioned blocks is an inter-partitioned block, the video encoding apparatus generates a prediction block of the remaining partitioned block that uses no motion compensation. The video encoding apparatus may blend the final prediction block of the inter-partitioned block and the prediction block of the remaining partitioned block to generate the final predicted signals of the current block.

In another example, when there are two inter-partitioned blocks, the video encoding apparatus may blend the final prediction blocks of the inter-partitioned blocks to generate the final predicted signals of the current block.

The video encoding apparatus encodes the GPM index and candidate index (S1416).

Then, the video encoding apparatus subtracts the final predicted signals of the current block from the current block to generate residual signals. The video encoding apparatus transforms/quantizes the residual signals to generate quantized transform coefficients and encodes the quantized transform coefficients.

FIG. 15 is a flowchart of a method of reconstructing a current block by the video decoding apparatus, according to at least one embodiment of the present disclosure.

The video decoding apparatus decodes the GPM index and candidate index from the bitstream (S1500).

As shown in Table 1, the GPM index may use the angle index angleIdx and the distance index distanceIdx to determine the partitioning boundary according to the geometric partitioning mode.

The video decoding apparatus constructs a GPM candidate list (S1502).

The video decoding apparatus may generate a regular motion vector candidate list and then may use the regular motion vector candidate list to generate a GPM (motion vector) candidate list.

The video decoding apparatus divides the current block into two partitioned blocks according to the GPM index (S1504).

The video decoding apparatus derives motion information from the GPM candidate list by using the candidate index for the inter-partitioned block that uses motion compensation between the partitioned blocks (S1506).

Here, at least one inter-partitioned block exists between the partitioned blocks. When two inter-partitioned blocks exist, the video decoding apparatus may use separate candidate indices to derive motion information for each inter-partitioned block.

The video decoding apparatus uses the motion information to generate a reference block of the inter-partitioned block (S1508).

The video decoding apparatus obtains LIC parameters (S1510). Here, the LIC parameters define the linear relationship between the reference block and the inter-partitioned block with LIC applied.

The video decoding apparatus applies LIC to the reference block of the inter-partitioned block based on the LIC parameters to generate the final prediction block of the inter-partitioned block (S1512).

The video decoding apparatus generates final predicted signals of the current block based on the final prediction block of the inter-partitioned block (S1514).

As an example, when one of the partitioned blocks is an inter-partitioned block, the video decoding apparatus generates a prediction block of the remaining partitioned block that uses no motion compensation. The video decoding apparatus may blend the final prediction block of the inter-partitioned block and the prediction blocks of the remaining partitioned blocks to generate the final predicted signals of the current block.

As another example, when there are two inter-partitioned blocks, the video decoding apparatus may blend the final prediction blocks of the inter-partitioned blocks to generate the final predicted signals of the current block.

The video decoding apparatus decodes the quantized transform coefficients from the bitstream, inversely quantizes/inversely transforms the quantized transform coefficients to reconstruct the residual block. The video decoding apparatus sums the final predicted signals of the current block and the residual block to generate the reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

124: inter predictor
544: inter predictor
902: prediction unit-determiner
904: prediction technique-determiner
906: prediction mode-determiner
908: prediction performer

### CROSS-REFERENCE TO RELATED APPLICATIONS

This application claims priority to and the benefit of Korean Patent Application No. 10-2023-0062654 filed on May 15, 2023, and Korean Patent Application No. 10-2024-0059176, filed on May 3, 2024, the entire contents of each of which are incorporated herein by reference.

What is claimed is:

1. A method of reconstructing a current block by a video decoding apparatus, the method comprising:
decoding a geometric partitioning mode (GPM) index and a candidate index from a bitstream;
constructing a GPM candidate list;
partitioning the current block into two partitioned blocks according to the geometric partitioning mode index;
deriving motion information from the GPM candidate list by using the candidate index for an inter-partitioned block utilizing motion compensation, wherein at least one inter-partitioned block exists between the partitioned blocks;
generating a reference block of the inter-partitioned block by using the motion information;
obtaining local illumination compensation parameters (LIC parameters) that define a linear relationship between the reference block and the inter-partitioned block when a local illumination compensation (LIC) applied; and
generating a final prediction block of the inter-partitioned block by applying the LIC to the reference block of the inter-partitioned block based on the LIC parameters.

2. The method of claim 1, wherein obtaining the LIC parameters comprises:
when a neighboring block, which provides the motion information, uses the LIC and is located within a template of the inter-partitioned block, inheriting the LIC parameters from the neighboring block.

3. The method of claim 1, wherein obtaining the LIC parameters comprises:
when a neighboring block, which provides the motion information, uses the LIC and is located within a template of the inter-partitioned block, deriving the LIC parameters by using a least-squares method based on pixel values in the template of the inter-partitioned block and pixel values in a template of the reference block.

4. The method of claim 1, wherein obtaining the LIC parameters comprises:
when a neighboring block, which provides the motion information, uses the LIC and is located within a template of the inter-partitioned block, deriving the LIC parameters by using a maximum pixel value and a minimum pixel value in the template of the inter-partitioned block, and a maximum pixel value and a minimum pixel value in a template of the reference block.

5. The method of claim 1, wherein obtaining the LIC parameters comprises:
when bi-prediction is applied to the inter-partitioned block, calculating first LIC parameters and second LIC parameters by using an iterative method based on a template of the inter-partitioned block, a template of a first reference block, and a template of a second reference block, the first LIC parameters representing a linear relationship between the template of the inter-partitioned block and the template of the first reference block, and the second LIC parameters representing a linear relationship between the template of the inter-partitioned block and the template of the second reference block.

6. The method of claim 5, wherein generating the final prediction block comprises:
generating a first prediction block of the inter-partitioned block by applying the LIC to the first reference block based on the first LIC parameters;
generating a second prediction block of the inter-partitioned block by applying the LIC to the second reference block based on the second LIC parameters; and
generating the final prediction block by weighted-summing the first prediction block and the second prediction block.

7. The method of claim 1, wherein obtaining the LIC parameters comprises:
when bi-prediction is applied to the inter-partitioned block, generating a reference template by weighted-summing a template of a first reference block and a template of a second reference block, and deriving the LIC parameters by using a template of the inter-partitioned block and the reference template.

8. The method of claim 7, wherein generating the final prediction block comprises:
generating a prediction block of the inter-partitioned block by weighted-summing the first reference block and the second reference block; and
generating the final prediction block by applying the LIC to the prediction block of the inter-partitioned block based on the LIC parameters.

9. The method of claim 3, wherein the template of the inter-partitioned block is determined based on a partitioning angle indicated by the geometric partitioning mode index, and the template of the reference block has an equivalent shape to the template of the inter-partitioned block.

10. The method of claim 3, wherein the template of the inter-partitioned block is determined based on a partitioning boundary, indicated by the geometric partitioning mode index and extended to a template of the current block, and
wherein the template of the reference block has an equivalent shape to the template of the inter-partitioned block.

11. The method of claim 1, further comprising, when one of the partitioned blocks is an inter-partitioned block:
generating a prediction block of a remaining partitioned block that does not utilize motion compensation; and
generating final predicted signals of the current block by blending the final prediction block of the inter-partitioned block with the prediction block of the remaining partitioned block.

12. The method of claim 1, further comprising, when two inter-partitioned blocks exist:
generating final predicted signals of the current block by blending final prediction blocks of the inter-partitioned blocks.

13. A method of encoding a current block by a video encoding apparatus, the method comprising:
determining a geometric partitioning mode (GPM) index and a candidate index;
constructing a GPM candidate list;
partitioning the current block into two partitioned blocks according to the geometric partitioning mode index;
deriving motion information from the GPM candidate list by using the candidate index for an inter-partitioned block utilizing motion compensation, wherein at least one inter-partitioned block exists between the partitioned blocks;
generating a reference block of the inter-partitioned block by using the motion information;
obtaining local illumination compensation parameters (LIC parameters) that define a linear relationship between the reference block and the inter-partitioned block when a local illumination compensation (LIC) applied; and
generating a final prediction block of the inter-partitioned block by applying the LIC to the reference block of the inter-partitioned block based on the LIC parameters.

14. The method of claim 13, further comprising:
encoding the geometric partitioning mode index and the candidate index.

15. The method of claim 13, further comprising, when one of the partitioned blocks is the inter-partitioned block:
generating a prediction block of a remaining partitioned block that does not utilize motion compensation; and
generating final predicted signals of the current block by blending the final prediction block of the inter-partitioned block with the prediction block of the remaining partitioned block.

16. The method of claim 13, further comprising, when two inter-partitioned blocks exist:
generating final predicted signals of the current block by blending final prediction blocks of the inter-partitioned blocks.

17. A method of providing video data to a video decoding apparatus, the method comprising:
encoding the video data into a bitstream; and
transmitting the bitstream to the video decoding apparatus,
wherein encoding the video data comprises:
determining a geometric partitioning mode (GPM) index and a candidate index;
constructing a GPM candidate list;
partitioning a current block into two partitioned blocks according to the geometric partitioning mode index;
deriving motion information from the GPM candidate list by using the candidate index for an inter-partitioned block utilizing motion compensation, wherein at least one inter-partitioned block exists between the partitioned blocks;
generating a reference block of the inter-partitioned block by using the motion information;
obtaining local illumination compensation parameters (LIC parameters) that define a linear relationship between the reference block and the inter-partitioned block when a local illumination compensation (LIC) applied; and
generating a final prediction block of the inter-partitioned block by applying the LIC to the reference block of the inter-partitioned block based on the LIC parameters.
